(19) United States
(12) Patent Application Publication
(10) Pub. No.: US 2004/0029030 A1
(43) Pub. Date: Feb. 12, 2004

(54) Method and apparatus for producing a durable image

(76) Inventor: Nicholas John Murray, Nantwich (GB)

Correspondence Address: MICHELE J. YOUNG, SALTER & MICHAELSON, 321 SOUTH MAIN STREET, PROVIDENCE, RI, 02903-7128, US

(21) Appl. No.: 10/421,643

(22) Filed: Apr. 23, 2003

Related U.S. Application Data
(63) Continuation-in-part of application No. PCT/GB01/04700, filed on Oct. 23, 2001.

(30) Foreign Application Priority Data
Oct. 23, 2000 (GB) 0025886.3

(51) Int. Cl. G03G 7/00

(52) U.S. Cl. 430/130; 428/203; 428/483; 156/243; 430/961; 430/9; 430/11; 430/18

(57) ABSTRACT

A method of forming a durable image including the steps of providing a substrate, depositing an image on the substrate, applying a curable coating over the image and curing the coating. The substrate may be formed from a plastics material, paper, card or any other suitable material. The image may be formed by ink, toner or the like. The coating is preferably curable by means of ultra violet light. The coating may be a transfer coating, transferred from a carrier. Alternatively the coating may be deposited by spraying onto the image. Apparatus for forming a durable image includes means for depositing an image on a substrate, means for applying a coating over the image and means for curing the coating.

### RELATED CASES

Benefit is hereby claimed under 35 U.S.C. § 365 of the filing date of International application PCT/GB01/04700, which was filed on Oct. 23,2001 and which is incorporated herein by reference in its entirety.

### TECHNICAL FIELD

The present invention relates to a method for producing a durable image, particularly but not exclusively a durable photo-realistic image comprising a gloss and/or a textured anti-scratch finish.

### BACKGROUND

Durable images can form, or be included in, articles such as signs, placards, posters, pictures and stickers, for use in a wide variety of applications such as advertising and display generally. Typically, such an article includes a laminate optically transparent protective cover surface and a substrate, such as a paper or polymeric sheet, carrying the required image. The image is generally produced by a conventional colour printing technique. The image-carrying sheet may be laminated to the optically transparent cover surface using an optically clear adhesive. If necessary, a protective backing surface may also be adhered to the sheet on the opposite side to the optically transparent cover surface. Such an image-carrying article is disclosed, for instance, in EP-A-0638019.

One problem with the use of conventional printing paper in the production of an image carrying article is that it may discolour, become scratched and/or degrade, particularly when used in adverse weather conditions. In applications where a high quality colour image is required, and for outdoor applications, an image-carrying paper substrate must be protected against ingress of water. For such applications it is known to encapsulate the image-carrying substrate or laminate, for instance by means of a plastic pouch which is heat-sealed around all sides of the laminate sheet.

Producing a durable high quality image using lamination techniques can be expensive and inconvenient. This is partly due to the cost of the optically transparent protective cover surface and adhesive materials used, which is generally significantly greater than the cost of the image-carrying sheet itself. In addition, it is generally necessary to use a lamination machine to apply the transparent protective cover. Heavy commercial rollers for wide format print laminating may cost in excess of £20,000 sterling. A third factor is the cost of printing the image itself, high quality colour printing and the silver halide film and print processing of conventional photographic techniques are expensive and time consuming. Conventional photographic techniques also require the use of wet and often toxic and hazardous chemicals which require particular methods of waste disposal. The production of such images and products can be relatively expensive, particularly when only a small number of prints are required.

It is an object of the present invention to provide a method for producing a durable image which overcomes or at least minimises the problems associated with existing print-lamination techniques. In particular, it is an object of this invention to provide a method for producing an image which is scratch-resistant, long lasting and preferably weather resistant. A further object of this invention is to provide a method for producing a high-quality, photo-realistic durable image without the use of toxic chemicals whilst retaining image quality. As used herein, a photo-realistic image means an image having a visual appearance comparable to a conventional silver halide print produced by wet bath and photographic chemistry. A further object of this invention is to provide an inexpensive alternative or equivalent to a conventionally laminated and textured photographic print which may include a high gloss finish or any of a wide variety of transfer coated surfaces.

### SUMMARY

The present invention is directed to, in one embodiment, a method of encapsulating an article within a coating of a substrate. The method involves the steps of providing a substrate, applying a receiving layer of a curable coating on the substrate, introducing an article to be encapsulated, applying a further layer of a curable coating to the substrate over the receiving layer and curing the coating, the article thereby being encapsulated within the coating.

In another embodiment, the invention is directed to a method of forming a vehicle registration plate incorporating an encapsulated authentication means. The method involves the steps of providing the text of the registration plate on a substrate, applying a receiving layer of a curable coating on to the substrate, introducing an authentication means to be encapsulated, applying a further layer of a curable coating to the substrate over the receiving layer and curing the coating, the authentication means thereby being encapsulated within the coating.

In yet another embodiment, the invention is directed to a method of forming a durable image comprising the steps of providing a substrate, depositing an image on the substrate, applying a curable coating over the image and curing the coating.

In another embodiment, the invention is directed to an apparatus for forming a durable image on a substrate. The apparatus includes means for depositing an image on a substrate, means for applying a curable coating over the image and means to cure the coating.

### BRIEF DESCRIPTION OF THE DRAWINGS

In order that the invention may be more clearly understood, embodiments thereof will now be described by way of example and with reference to the accompanying drawings in which:

FIG. 1 is a plan view of a durable image;

FIG. 2 is a cross-sectional view of the image of FIG. 1, taken along the line A-A of FIG. 1;

FIG. 3 is a schematic view of an embodiment of apparatus according to the invention; and

FIG. 4 is a schematic view of another embodiment of apparatus according to the invention.

### DETAILED DESCRIPTION OF THE PREFERRED EMBODIMENTS

According to a first aspect of the present invention there is provided a method of forming a durable image comprising the steps of: providing a substrate; depositing an image on the substrate; applying a curable coating over the image; and curing the coating.

In a preferred embodiment, the durable image is a photo-realistic durable image with the feel and appearance of an optically bright gloss or textured photograph.

The substrate may form a rigid platform on which the image is formed and may be capable of independent existence in the absence of any further supporting base.

The substrate may be absorbent or not absorbent to the image-forming material, i.e. ink or toner.

The substrate should be thermally and dimensionally stable under the conditions used in the image deposition process, which may involve passage of the substrate through a photocopier or laser printer. The temperature of a copier fuser roller, for example, is normally at least 150° C., and typically in the range of 160 to 190° C. Although the substrate is exposed to the heat of the roller for only a short time during the image production it can become degraded, twisted and buckled, or even melt. In general, the substrate should be capable of withstanding a temperature of at least 150° C. and preferably at least 190° C. without substantial instantaneous degradation, structural change, dimensional change, or colour change. Most preferably the substrate should be such that it is thermally and dimensionally stable when exposed to a temperature of 200° C. for at least 0.5 seconds.

The substrate may include a thermoplastics polymeric material, and may be formed from any suitable film-forming polymeric material. Such materials include homopolymers or copolymers of a 1-olefin (including ethylene, propylene and but-1-ene), polyamides, polycarbonates, PVC, PVA, polyacrylates, celluloses and polyesters. Preferably the substrate and coating carrier include a polyester, particularly a synthetic-linear polyester.

The synthetic linear polyesters useful as the substrate may be obtained by condensing one or more dicarboxylic acids or their lower alkyl (up to 6 carbon atoms) diesters, eg terephthalic acid, isophthalic acid, phthalic acid, 2,5-, 2,6-, or 2,7-naphthalenedicarboxilic acid, succinic acid, sebacic acid, adipic acid, azelaic acid, 4,4⁷-diphenyldicarboxylic acid, hexahydro-terephthalic acid or 1,2-bis-p-carboxyphenoxyethane (optionally with a monocarboxylic acid, such as a pivalic acid) with one or more glycols, particularly an aliphatic or cycloaliphatic glycol, eg ethylene glycol, 1,3-propanediol, 1,4-butanediol, neopenthyl glycol and 1,4-cyclohexanedimethanol. An aliphatic glycol is preferred.

In a preferred embodiment, the polyester is polyethylene terephthalate (PET) or a copolyester thereof with other co-monomeric units, as set out above.

The substrate may also include a polyarytether or analogue thereof, particularly a polyaryletherketone, polyarylethersulphone, polyaryletheretherketone, polyaryletherethersulphone, or a copolymer or thioanalogue thereof. Examples of these polymers are disclosed in EP-A-001879, EP-A-0184458 and U.S. Pat. No. 4,008,203. Blends of such polymers may also be employed.

The substrate may include one or more discrete layers of the above film-forming materials. For instance, the substrate may include one, two, three, four or five or more layers. The polymeric materials of the respective layers may be the same or different. In a preferred embodiment the film may include a multilayer substrate comprising two or three, preferably two, different types of layer. Typical multilayer structures may be of the AB, ABA, ABC, ABABA, or ABCBA type. Where the substrate includes more than one layer, preferably at least one of the layers includes polyethylene terephthalate.

Formation of the substrate may be effected by conventional techniques well known in the art. Conventionally, formation of the substrate is effected by extrusion, in accordance with the procedure described below. In general terms the process includes the steps of extruding a layer of molten polymer, quenching the extrudate and orienting the quenched extrudate in at least one direction.

The substrate may be uniaxially oriented, but is preferably biaxially oriented by drawing in two mutually perpendicular directions in the plane of the film to achieve a satisfactory combination of mechanical and physical properties. Orientation may be effected by any process known in the art for producing an oriented film, for example a tubular or flat film process.

In a tubular process, simultaneous biaxial orientation may be effected by extruding a thermoplastics polyester tube which is subsequently quenched, reheated and then expanded by internal gas pressure to induce transverse orientation, and withdrawn at a rate which will induce the longitudinal orientation.

In a preferred flat film process, the substrate-forming polyester is extruded through a slot die and rapidly quenched upon a chilled casting drum to ensure that the polyester is quenched to the amorphous state. Orientation is then effected by stretching the quenched extrudate in at least one direction at a temperature above the glass transition temperature of the polyester. Sequential orientation may be effected by stretching a flat, quenched extrudate firstly in one direction, usually the longitudinal direction, i.e. the forward direction through the film stretching machine, and then in the transverse direction. Forward stretching of the extrudate is conveniently effected over a set of rotating rollers or between two pairs of nip rollers, transverse stretching then being effected in a strenter apparatus. Stretching is effected to an extent determined by the nature of the polyester, for example polyethylene terephthalate is usually stretched so that the dimension of the oriented film is from 2 to 5, more preferably 2.5 to 4.5 times its original dimension in the or each direction of stretching. Typically, stretching is effected at temperatures in the range of 70 to 125° C. Greater draw ratios (for example up to about 8 times) may be used if orientation in only one direction is required. It is not necessary to stretch equally in the machine and transverse directions although this is preferred as balanced properties are desired.

A stretched film may be, and preferably is, dimensionally stabilized by heat-setting under dimensional restraint at a temperature above the glass transition temperature of the polyester but below the melting temperature thereof, to induce crystallization of the polyester. In applications where the film shrinkage is not of significant concern, the film may be heat set at relatively low temperature or not at all. On the other hand, as the temperature at which the film is heat set is increased, the tear resistance of the film may change. Thus, the actual heat set temperature and time will vary depending on the composition of the film and its intended application but should not be selected so as to substantially degrade the tear resistant properties of the film. Within these constraints, a heat set temperature of about 135 to 250° C. is generally desirable, as described in GB-A-838708.

Where the substrate includes more than one layer, preparation of the substrate is conveniently effected by coextrusion, either by simultaneous coextrusion of the respective film-forming layers through the independent orifices of a multi-orifice die, and thereafter uniting the still molten layers, or preferably by single-channel coextrusion in which molten streams of the respective polymers are first united within a channel leading to a die manifold, and thereafter extruded together from the die orifice under conditions of streamline flow without intermixing thereby to produce a multilayer polymeric film, which may be oriented and heat-set as hereinbefore described. Formation of a multilayer substrate may also be effected by conventional lamination techniques, for example by laminating together a preformed first layer and a preformed second layer, or by casting, for example, the first layer onto a preformed second layer.

The substrate may conveniently contain any of the additives conventionally employed in the manufacture of polymeric films. Thus agents such as cross-linked agents, dyes, pigments, voiding agents, lubricants, anti-oxidants, radical scavengers, UV absorbers, thermal stabilizers, anti-blocking agents, surface active agents, slip aids, optical brighteners, gloss improvers, prodedradents, viscosity modifiers and dispersion stabilizers may be incorporated in the substrate layer as appropriate. In particular the substrate may include a particulate filler. The particulate filler may, for example, be a particulate inorganic filler or an incompatible resin or a mixture of two or more such fillers.

By an “incompatible resin” is meant a resin which either does not melt, or which is substantially immiscible with the polymer, at the highest temperature encountered during extrusion and fabrication of the film. The presence of an incompatible resin usually results in a voided layer, by which is meant that the layer includes a cellular structure containing at least a proportion of discrete, closed cells. Suitable incompatible resins include polyamides and olefin polymers, particularly a homo- or co-polymer of a mono-alpha-olefin containing up to 6 carbon atoms in its molecule. Preferred materials include a low or high density olefin homopolymer, particularly polyethylene, polypropylene or poly-4-methylpentene-1, an olefin copolymer, particularly an ethylene-propylene copolymer, or a mixture of two or more thereof. Random, block or graft copolymers may be employed.

Particulate inorganic fillers include conventional inorganic fillers, and particularly metal or metalloid oxides, such as alumina, silica (especially precipitated or diatomaceous silca and silica gels) and titamia, calcined china clay and alkaline metal salts, such as carbonates and sulphates of calcium and barium. The particulate inorganic fillers may be of the voiding or non-voiding type. Suitable particulate inorganic filler may be homogeneous and consist essentially of a single filler material or compound, such as a titanium dioxide or barium sulphate alone. Alternatively, at least a proportion of the filler may be heterogenous, the primary filler material being associated with an additional modifying component. For example, the primary filler particle may be treated with a surface modifier, such as a pigment, soap, surfactant coupling agent or other modifier to promote or alter the degree to which the filler is compatible with the substrate layer polymer.

Preferred particulate inorganic fillers include titanium dioxide and silica.

Titanium dioxide particulates may be of anatase or rutile crystal form. The titanium dioxide particles preferably include a major portion of rutile, more preferably at least 60% by weight, particularly at least 80%, and especially approximately 100% by weight of rutile. The particles can be prepared by standard procedures, such as the chloride process or the sulphate process. The titanium dioxide particles may be coated, preferably with inorganic oxides such as aluminium, silicon, zinc, magnesium or mixtures thereof. Preferably the coating additionally includes organic compound(s) such as fatty acids and preferably alkanols, suitably having from 8 to 30, preferably from 12 to 24 carbon atoms. Polydiorganosiloxanes or polyorganohygonsiloxanes, such as polymidethysiloxane or polymethylhydrogensiloxane are suitable organic compounds. The coating is suitably applied to the titanium dioxide particle in aqueous suspension. The inorganic oxides are precipitated in aqueous suspension from water-soluble compounds such as sodium aluminate, aluminium sulphate, aluminium hydroxide, aluminium nitrate, silicic acid, or sodium silicate. The coating layer on the titanium dioxide particles is preferably in the range from 1 to 12% of organic oxides, and preferably in the range from 0.5 to 3% of organic compound, by weight based upon the weight of titanium dioxide.

The inorganic filler should be finely-divided, and the volume distributed median particle diameter (equivalent spherical diameter corresponding to 50% of the volume of all the particles, read on the culmative distribution curve relating volume % to the diameter of the particles—often referred to as the “D(v,0.5)” value) thereof is preferably in the range from 0.01 to 5 microns, more preferably 0.05 to 1.5 microns, and particularly 0.15 to 1.2 microns.

The size distribution of the inorganic filler particles is also an important parameter, for example the presence of excessively large particles can result in the film exhibiting unsightly “speckle”, i.e. where the presence of individual filler particles in the film can be discerned with the naked eye. It is preferred that none of the inorganic filler particles incorporated into the substrate layer should have an actual particle size exceeding 30 microns. Particles exceeding such a size may be removed by sieving processes which are known in the art. However, sieving operations are not always totally successful in eliminating all particles greater than the chosen size. In practice, therefore, the size of 99.9% by the number of the inorganic filler particles should not exceed 30 microns, preferably should not exceed 20 microns, and more preferably should not exceed 15 microns. Preferably at least 90%, more preferably at least 95% by volume of the inorganic filler particles are within the range of volume distributed median particle diameter ±0.8 microns, and particular ±0.5 microns.

Particle size of the filler particles may be measured by electron microscope, coulter counter, sedimentation analysis and static or dynamic light scattering. Techniques based on laser light diffraction are preferred. The median particle size may be determined by plotting a cumulative distribution curve representing the percentage of particle volume below chosen particle sizes and measuring the 50^{th} percentile.

The substrate may be opaque, translucent or transparent.

In the preferred embodiment, the substrate layer is opaque and highly filled, preferably exhibiting a Transmission Optical Density (TOD) Sakura Densitometer, type PDA 65; (transmission mode) in the range from 0.1 to 2.0, more preferably 0.2 to 1.5, more preferably from 0.25 to 1.25, more preferably from 0.35 to 0.75 and particularly 0.45 to 0.65. The substrate layer is conveniently rendered opaque by incorporation into the polymer blend of an effective amount of an opacifying agent. Such opacifying agents include incompatible resin filler, a particulate inorganic filler or a mixture of two or more such fillers, as hereinbefore described. The amount of filler present in an opaque substrate layer is preferably in the range from 1% to 30%, more preferably 3% to 20%, particularly 4% to 15% and especially 5% to 10% by weight, based on the weight of the substrate layer polymer. An opaque substrate may be white or pigmented, and is preferably white. The surface of an opaque substrate layer preferably exhibits a whiteness index, measured as herein described, in the range from 60 to 120, more preferably 80 to 110, particularly 90 to 105, and especially 95 to 100 units.

In an alternative embodiment the substrate layer of the present invention is optically clear, preferably having a % of scattered visible light (haze) of <10%, preferably <6%, more preferably <3.5% and particularly <2%, measured according to the standard ASTM D1003. In this embodiment, filler is typically present in only small amounts, generally not exceeding 0.5% and preferably less than 0.2% by weight of the substrate.

The thickness of the substrate is preferably between about 20 and 200 microns, more preferably between about 50 and 150 microns, still more preferably between about 90 to 120 microns. Typically, the substrate is about 100 microns thick.

Further examples of substrates suitable for use in the present invention are described in EP-A-0408197 and WO-A-97/37849, the disclosures of which are incorporated herein by reference.

Preferably, the substrate is treated or coated to improve the adhesion of the image-forming substance hereto. The identity of the image-forming substance will, of course, depend on the method used to form the image and includes the toners and inks used in equivalent electrostatic copying and printing methods, and the other image-forming processes mentioned herein.

In one embodiment the substrate, particularly a PET polyester substrate, is coated with a primer layer such as those disclosed in EP-A-0408197, EP-A-0429179, EP-A-0576179 or WO-A-97/37849, the disclosures of which are incorporated herein by reference. Preferably, the primer layer includes an acrylic and/or methacrylic polymeric resin and optionally includes a cross-linking agent. Cellulosic materials may also be used.

Suitable polymers for the primer layer include at least one monomer derived from an ester of acrylic acid, especially an alkyl ester where the alkyl group contains up to ten carbon atoms (including methyl, ethyl, n-propyl, isopropyl, n-butyl, isobutyl, terbutyl, hexyl, 2-ethylhexyl, heptyl and n-octyl). Polymers derived from an alkyl acrylate, for example ethyl acrylate and methyl methacrylate are preferred. Polymers comprising ethyl acrylate and methyl methacrylate are particularly preferred. The acrylate monomer is preferably in a proportion in the range 30 to 65 mole %, and the methacrylate monomer is preferably present in a proportion in the range of 20 to 60 mole %.

Other monomers which are suitable for use in the preparation of the polymeric resin of the primer layer, which may be copolymerised as optional addition monomers together with esters of acrylic acid and/or methacrylic acid, and derivatives thereof, include acrylonitrile, methacrylonitrile, halo-substituted acrylonitrile, halo-substituted methacrylonitrile, acrylamide, methacrylamide, N-methynol acrylamide, -ethanol acrylaminide, N-propanol acrylamide, N-methacrylaminide, -ethanol methacrylaminide, -methyl acrylaminide, N-tertitiary butyl acrylamide, hydroxythyl methacrylate, glycidyl acrylate, glycidyl methacrylate, dimethylamino ethyl methacrylte, itaconic acid, itaconic anhydride and halfester ofitaconic acid. Other optional monomers of the primer layer polymer include vinyl esters such as vinyl acetate, vinyl chloracetate, vinyl benzoate, vinyl pyridine, vinyl chloride, vinylidene chloride, maleic acid, maleic anhydride, styrene and derivatives of styrene such as chloro styrene, hydroxy styrene and akrylated styrenes, wherein the alkyl group contains from one to ten carbon atoms.

A preferred primer layer polymer includes 35 to 60 mole % ethyl acrylate, 30 to 55 mole % of methyl methacrylate and 2 to 20 mole % of methacrylamide.

The molecular weight of the primer layer polymer can vary over a wide range but is preferably within the range 40,000 to 300,000, and more preferably within the range 50,000 to 200,000.

The primer layer composition may also contain a cross-linking agent which improves adhesion of the primer layer to the substrate. Additionally, the cross-linking agent should preferably be capable of internal cross-linking in order to provide protection against solvent penetration. A cross-linking agent can also provide extra rigidity to the coated-substrate which improves the dimensional stability during the image-deposition process.

Suitable cross-linking agents may include epoxy resins, alkyd resins, amine derivatives such as hexamethoxymethyl melamine, and/or condensation products of an amine, e.g. melamine, diazine, urea, cyclicethylene urea, cyclic propyelene urea, thioureau, cyclic ethylene thiourea, alkyl melamines, and melamines, benzo guanamines, alkyl guanamines and aryl guanamines, with an aldenhyde, e.g. formaldehyde. A useful condensation product is that of melamine with formaldehyde. The condensation product may optionally be alkoxylated. The cross-linking agent is preferably used in amounts of up to 25% by weight based on the weight of the polymer in the coating composition. A catalyst is also preferably employed to facilitate the cross-linking action of the cross-linking agent. Preferred catalysts for cross-linking melamine formaldehyde include ammonium chloride, ammonium nitrate, ammonium thiocyanate, ammonium dihydrogen phosphate, ammonium sulphate, diammonium hydrogen sulphate, para toluene sulphonic acid, maleic acid stabilized by reaction with a base, and morpholiniumpara toluene sulphonate.

The polymer of the primer layer composition is generally water-insoluble. The coating composition including the water-insoluble polymer may nevertheless by applied to the substrate as an aqueous dispersion or alternatively as a solution in an organic solvent. Any suitable conventional coating technique such as dip coating, bead coating, reverse roller coating or slot coating may be used. The coating medium may be applied to an already oriented film substrate. However, application of the coating medium is preferably effected before or during the stretching operation. In particular, it is preferred that the primer layer medium should be applied to the film substrate between the two stages (longitudinal and transverse) of the biaxial stretching operation. Such a sequence of stretching and coating is especially preferred for the production of a coated linear polyester film substrate, such as a coated polyethylene terephthalate film, which is preferably firstly stretched in the longitudinal direction over a series of rotating rollers, coated, then stretched transversely in a stenter oven, preferably followed by heat-setting.

A primer layer composition applied to the substrate is preferably applied as an aqueous dispersion. The temperatures applied to the coated film during the subsequent stretching and/or heat-setting are effective in drying the aqueous medium, or the solvent in the case of solvent applied compositions, and also, if required, in coalescing and forming the coating into a continuous and uniform layer. The cross-linking of the cross-linkable primer lay compositions is also achieved at such stretching, and preferably at such heat setting temperatures.

In order to produce a continuous coating, the primer layer is preferably applied to the polymeric film at a coat weight within the range 0.1 to 1.0 mgdm⁻², especially 0.2 to 2.0 mgdm⁻², as known in the art. A discontinuous layer can be produced, for instance on the reverse side of the substrate, by applying a coat weight of less than 0.1 mdgm⁻², which may improve the slip properties of the film.

Modification of the surface of the primer layer, e.g. by flame treatment, ion bombardment, electron beam treatment, ultra-violet light treatment or preferably by corona discharge, may further improve the adhesion of subsequently applied coatings or toner powders.

The preferred treatment by corona discharge may be effected in air at atmospheric pressure with conventional equipment using a high frequency, high voltage generator, preferably having a power output of from 1 to 20 KW at a potential of 1 to 100 KV. Discharge is conveniently accomplished by passing the film over a dielectric support roller at the discharge station at a linear speed preferably of 1.0 to 500 m per minute. The discharge electrodes may be positioned 0.1 to 10,0 mm from the moving film surface.

Prior to deposition of the primer layer onto the substrate, the exposed surface of the substrate may be subjected to a chemical or physical surface-modifying treatment to improve the bond between the substrate and the subsequently applied primer layer.

A preferred treatment, because of its simplicity and effectiveness, is to subject the exposed surface of the substrate to a high voltage electrical stress accompanied by a corona discharge.

Alternatively, the substrate may be pretreated with an agent known in the art to have a solvent or swelling action on the substrate polymer. Examples of such agents, which are particularly suitable for the treatment of a polyester substrate, include a halogenated phenol dissolved in an organic solvent, e.g. a solution of p-chloro-m-cresol, 2,4-dichlorophenol, 2,4,5- or 2,4,6-trichlorophenol or 4-chlororesorcinol in acetone or methanol.

The ratio of the thickness of the substrate and the primer layer may vary within a wide range, although the thickness of the primer layer preferably should not be less than 0.004% nor greater than 10% of that of the substrate. In practice, the thickness of the primer layer is desirably at least 0.01 microns and preferably should not greatly exceed about 1.0 microns.

The primer layer may conveniently contain any of the additives conveniently employed in the manufacture of the polymeric films, as described above. The primer layer preferably includes a particulate filler, such as a silica, preferably in an amount of not exceeding 50% by weight of the polymeric material and the particle size thereof should not exceed 0.5 microns, and is preferably less than 0.3 microns, and is especially in the range from 0.005 to 0.2 microns. The primer layer preferably contains 5 to 15% by weight, and particularly 10% of filler(s). The use of a filler in the primer layer is of particular benefit since it increases the surface roughness of the film, thereby improving the feeding characteristics of the film in photocopiers and printers. This is of particular use when the image-deposition process is effected by using a high-speed electrostatic copying machine.

A primer layer may be provided on one or each surface of the substrate, and an image may thus be generated on one or each side of the substrate. Image deposition may be effected directly onto the primer layer. However, it is preferred that the substrate includes an additional receiving layer applied on top of the primer layer. Image deposition is preferably then effected onto the receiving layer. The composition of the receiving layer will vary depending on the image deposition method used. A receiving layer preferably has a thickness of about 5 to about 15 microns, and may be applied on each side of the substrate.

For instance, a receiving layer for an electrostatically applied image may contain conductive particles in order to improve the conductivity required to obtain optimum image quality in colour and monochrome photocopiers and laser printers, as is well known in the art. The resistivity of such a receiving layer is preferably in the range 1 to 10 Gohms per square. The type and concentration of conductive particle in the receiving layer may vary as appropriate to the print application being used. The receiving layer may include a mixture of polymeric antistatic resins and adhesion promoters. Receiving layers suitable for electrostatic methods of image deposition are described, for example, in U.S. Pat. No. 5,663,030 and the prior art referenced therein, the disclosures of which are incorporated herein by reference.

Receiving layers suitable for receiving an image applied by an ink-jet method are well-known in the art and include, for instance, layers such as those described in EP-A-0696516 and U.S. Pat. No. 588,635, the disclosure of which is incorporated herein by reference.

If desired, an anti-static coating medium may be applied. Suitable antistatic coatings are described, for instance, in EP-A-0027699 and U.S. Pat. No. 5,453,326 and U.S. Pat. No. 5,882,800, the disclosures of which are included herein by reference. The static friction of the substrate can be reduced by applying a wax, for example a natural wax, such as a canuba wax, or a synthetic wax, to one or both surfaces of the substrate, the wax coating on that surface carrying the receiving layer being applied over that layer. These precautions facilitate the feeding of single sheets from a stack of sheets in a high speed copying machine.

A preferred polyethylene substrate is commercially available as Melinex Film from DuPont. Preferred grades for use in the present invention include Melinex 542, Melinex 506 and Melinex 347 film.

The substrate could also be formed from materials other than plastics materials, for example paper, cardboard, wood, metal, MDF, rubber, glass, leather and magnetic materials. The substrate may be absorbent. The substrate could also include a printed circuit, plastic circuit, micro component, semi conductor or pharmaceutical.

### Image Deposition

The image, which may of course be a colour image, is preferably deposited on the substrate in a manner such that a photo-realistic image is produced. Preferred methods include electrostatic deposition by photocopier or laser printer and ink-jet application by an ink-jet printer. Thermal transfer, dye-sublimination, gravure fine printing, screen printing and dye transfer pictography may also be used. A toner printing process wherein the various pigments (including black, cyan, magenta, yellow, red, blue, green and white pigment(s)) and colourant(s) are deposited may also be used. Preferably the image is deposited by an electrostatic process, and preferably by an electrostatic copying process. In one embodiment, the image is formed by a conventional electrostatic copying technique using a thermally fusible (thermoplastics) toner powder. Available toner powders include those based on styrene-acrylate copolymers, and blends thereof.

Electrostatic copying machines are well-known and generally available. Any conventional and commercially available printer or photocopier can be used in the process of the present invention including those marketed by Canon, Eastman Kodak, Xerox, Ricoh, Minolta, Oce. Machines of this nature generally operate by initially depositing a uniform positive electrostatic charge from a corona discharge electrode onto a drum having a photoconductive surface, e.g. a selenum coated drum, maintained in a dark environment. The charged surface is then exposed to a light image of the original document or representation to be copied, whereby the charge is dissipated and flows to earth from those areas of the drum struck by light.

The discharge is not affected in the dark areas masked by the original document or representation. The image is then formed by passing negatively charged coloured thermoplastic toner powder over the light-exposed drum so that the powder is electrostatically attracted to the residual charged areas of the drum surface. The thus-formed toner powder image may be transferred to the film substrate by placing the substrate over the toner image and positively charging the substrate by corona discharge so that the toner powder is attracted to the substrate by the residual negative charge on the toner powder. Finally, the substrate may be heated and/or chemically treated to fuse the toner powder and bond it to the substrate as an image layer.

In conventional electrostatic copying processes, thermal bonding of fusible toner powder to a film substrate is generally effected at relatively high fusion temperatures, for example at about 160-190° C., and is commonly achieved by infra-red heating. However, somewhat lower temperatures, in the region of 120° C., applied by heated rollers or ultra-violet lamps may also be used.

A stabilizer or fuser used to fix the toner powder to the substrate is typically a silicone material such as a silicone oil, which remains on the surface of the image. However, this silicone-containing material may inhibit adhesion of the subsequently-applied optically clear/or colour pigmented UV curable transfer coating to the surface of the image-carrying substance in the method of the present invention. Thus, in one embodiment of the present invention, the silicone-containing stabilizer is removed from the image-carrying substrate, for example by gentle washing and/or wiping with a cleaning liquid or solution. The cleaning liquid or solution may be applied to a damp cloth and used to wipe away the adhesion-inhibiting stabilizer from the surface of the image-carrying substrate.

Alternatively, the image-carrying substrate can be immersed in a bath of the cleaning liquid or solution. In a further embodiment, the solution may be applied as a wash process inside a coating machine, or by means of detergent-impregnated wipes. A spray may also be used, for instance a hand held spray with a hand-pump trigger action. Thus, a fine spray of the solution can be applied onto the surface of the image-carrying substrate and the liquid wiped away and the surface thoroughly dried using a clean, soft, lint-free cloth.

Any aqueous or non-aqueous liquid or solution capable of removing the adhesion-inhibiting stabilizer from the surface of the image-carrying substrate can be used, provided that the image is not disturbed and that the substrate is not discoloured or degraded. It is preferred to use an aqueous soap or detergent solution. Suitable liquids are those that do not scratch or damage the surface of the image, are smear-free and stain-free, are non-toxic, and do not give off unpleasant or hazardous vapours or fumes. Conveniently, commercial liquid detergents such as Fairy Liquid or Palmolive may be used, for instance as an aqueous solution of a few drops of the detergent in a litre of water.

The washing process, where necessary, is generally carried out below about 60° C., and conveniently at ambient temperature. However, any temperature that will not affect the substrate or image may be used.

Not all the image-deposition processes which may be used in the method of the present invention utilise silicone-based stabilisers and consequently the step of removing any adhesion-inhibiting stabiliser is not always necessary. For example, in an ink-jet process, the deposited liquid ink dries in air and requires no application of a stabilizing material.

The preferred image deposition methods according to the present invention produce a “relief” image on the substrate. In other words, an image is formed by regions of image-forming toner or ink which forms contours on the surface of the substrate, i.e. the toner or ink adheres to the surface of the substrate rather than being absorbed into the substrate, as occurs for instance with paper substrates. It is believed that it is the “relief” image produced by the preferred electrostatic deposition methods according to the present invention which results in the photorealism of the images produced by the present invention. However, it is not intended that the scope or the invention be limited by this theory.

The image could be formed by a water based and/or curable ink, particularly a UV curable ink.

### The Curable Coating

The technology and use of curable coatings and radiation-curable coatings in particular is well-established and many such coatings are commercially available (see The International Radiation Curing Yearbook and Directory (1998; DMG Business Media Ltd UK) which provides a useful review of the art (pages 2 to 20), the disclosure of which is incorporated herein by reference).

One suitable curable coating for use in the present invention includes an acrylate resin and is preferably solvent free. Examples include epoxy acrylates, polyether acrylates, polyester acrylates, urethane acrylates, silione acrylates and amine-functional and polyether acrylates. Preferably the coating is cured by radiation, preferably exposure to ultraviolet (UV) radiation. Cold curing of the coating is advantageous in that distortion and curling of the substrate, and damage to the deposited image is minimized. A radiation-cured coating includes one or more photo-initiators which may use one or both of intermolecular and intramolecular mechanisms. Other types of radiation curable coating include carionic, thiolene, unsaturated polyester or maleate/vinyl ether type curable resins.

In one embodiment the coating is an optically clear UV curable transfer coating, and may be tinted if desired, and is preferably a viscous gel transfer coating which may contain one or more additives such as an optical brightener to enhance its optical clarity over the photo-realistic image.

However, the curable coating may be applied onto the image-carrying substrate by any other suitable means including electronic delivery, thermal transfer screening, spraying and roller application. In one embodiment, an electronic spray head, similar to those used in ink-jet printers is used. In a further embodiment the coating is applied using disposable sachets or refillable cartridges, optionally mounted on a coating levelling device such as a levelling blade.

For an acrylate resin the dry thickness of the applied coating is preferably between about 1.5 and 50 microns, more preferably between 10 and 30 microns and still more preferably between about 10 and 25 microns. Typically the coating is about 20 microns thick. A polyurethane coating may also be used. The dry thickness of such a coating is preferably between 1 and 20 microns. In one embodiment, the coating is sufficiently thin so that it is able to follow the contours of the relief effect created by varying depths of toner on the substrate, thereby resulting in the coating having a contoured surface. In an alternative embodiment, the coating is sufficiently thick that peaks and troughs in the image layer are not expressed in the surface of the lacquer layer and a smooth gloss finish is provided.

Examples of suitable lacquers include IN7LZ441 and IN7UC746 (Akzo Nobel Industrial Coatings Ltd, UK). Further examples of suitable lacquers include the radiation curable lacquers commercially available as Crodamer UVE series, UPV series, UVU series, UVS series and a UVA series (Croda Resins Ltd, UK) and the radiation curable cationic epoxide resins and associated materials available as Cycacure (Union Carbide Corporation, Connecticut, USA; as described, for example, in Cyracure Cycloaliphtic Epoxides Cationic UV Cure (1995), the disclosure of which regarding specific formulations is incorporated herein by reference).

A preferred transfer coating of the present invention includes a viscous or thickened UV curable transfer coating comprising optical brighteners, hardeners, and anti-scratch additives. One such coating is an optically clear Akzo Novel CND755D coating supported on a transparent polyester carrier film having thereon at least one side a smooth gloss surface, or an embossed or textured surface. The UV coating remains attached to the carrier film until after the coating has cured, that is to say the coating is exposed to UV light and curing takes place through the carrier film. After the transfer coating has cured the carrier film may be peeled from the coated image to reveal the replicated texture on the cured coating which may be, for example, a canvass texture on a photo-realistic image of the present invention.

Another suitable coating is a UV curable polyurethane transfer coating.

A curable transfer coating may be applied onto the image-carrying substrate by any suitable means. However, the preferred method is by passing the imaged layer and the coated carrier layer jointly between a pair of heated rollers under pressure. For example, the preferred Akzo Nobel optically clear UV curable transfer coating is a hot melt coating which may be applied to sheets and rolls of transparent gloss Melinex polyester film at a temperature of 60 to 120° C., more preferably 80° C. The carrier film is preferably about 100 microns in thickness. Once the coating has cooled the transparent layers can be applied to the image-carrying substrate by laminating the transparent film and the optically clear coating using heat and pressure onto the substrate over the image. The carrier layer remains attached to the UV transfer coating and the layers are exposed to a UV light source to cure the coating. The carrier layer does not inhibit UV curing through the film. Preferably a micro-wave generated light source is used to power cold curing UV lamps. Subsequently the carrier layer is removed from the cured coating to reveal a smooth gloss or a textured finish. The effect is created by use of a wide variety of smooth and textured carrier layers which, when cured, are replicated into the cured coating. For example, a highly polished gloss carrier film will produce a gloss finish, whilst a canvas carrier will be replicated in fine detail.

The carrier film may be coated with a release agent, which may include silicone, to facilitate release of the cured coating.

An important advantage of the present invention is versatility and ease of use. For example, a single mix of optically clear UV curable transfer lacquer can be used to produce many kinds of surfaces and finishes. In a further example a high-gloss, semi-gloss, opaque, matt, water-mark, canvas, silk, sand-stone, fabric, wood-grain, slate, parchment, brick, embossed stamp or any other suitably transferable surface or texture is replicated into the coating by the carrier film for example textured carriers can be used to apply decorative textures onto flooring and metal-cladding sheets and signs. Additionally using a carrier with a lenticular surface texture means that 3D lenticular lenses can be formed in an optically clear coating applied over lenticular printed images used in large format advertising, 3D birthday cards, 3D printed self adhesive vinyl, and low cost lenticular images printed onto cans, metal boxes, bottles, and all kinds of packaging.

A UV curable transfer coating is preferably cured through a transparent carrier film layer in an air-free curing environment therefore eliminating ozone emissions and odour which are produced using conventional UV curing methods. In a further example, the curing speed of the transfer coating is increased and the hardness of the coating is improved.

In one embodiment the UV curable transfer coating used is a thick hot melted optically clear coating, that is to say a viscous coating which requires heat to activate and improve its flow and adhesion. Such a transfer coating is a thickened “Solar” UV Toner-Protection Transfer Coating CND755D manufactured by Akzo Nobel Industrial Coatings Ltd, Hollins Road, Darwen, Lancashire, BB5 0BG. The UV transfer coating is a hot melt coating which can be applied onto a wide range of smooth and/or textured surface carrier films by any hot melt coating method

Wetting and levelling of the transfer coating can be adjusted by modifying the flow characteristics of the coating with flow modifiers, such as surfactants, silicones and fluorinated alkyl esters, as is well known in the art. Brief exposure to a UV radiation can reduce the surface tension in a filmic carrier layer, thereby allowing a heated mixture to wet out and be coated evenly across the transparent filmic carrier layer. However, this action is not always deemed necessary.

The coating may include optical brighteners, surface hardeners, anti sink and anti-scratch additives.

The coating may contain functional and/or decorative materials for example photochromic and/or thermochromic materials. Such a coating containing functional or decorative material provides a method of transferring such functional or decorative materials from being provided in the coating on a carrier to being provided on a desired substrate. This allows the this method to be used for the transfer of fine line print and photorealistic images comprising solid inks, toners, pigments, particles, primers, and paints from a coating to a substrate, such lines and images being applied to the coating by any suitable means. Furthermore this method is suitable for applications in the canning printing industries and for multi-layer security applications including micro and nano-electronics, and is also suitable for transferring printed organic polymers and organic light emitting diodes from a coating to a substrate to form light emitting flat screen displays or other organic printed circuits. This method allows conductive plastic printed circuits formed by nano-dot inkjet depositions to be placed over whole or part areas of a circuit board provided as a substrate.

The transfer of such organic light emitting diodes from a coating to a substrate allows a variety of rigid or flexible low voltage flat screen displays and roll up flexible displays to be formed. Additionally the carrier for the transfer coating can be bent around shapes or hot formed by vacuum moulding or other suitable moulding technique before being UV cured. The carrier layer can then be removed leaving a display unit adapted to conform to the shape of the mould.

### Transfer Coatings on Metal

In a further embodiment the UV curable transfer coating of the present invention is pigmented and/or coloured, and then coated onto a layer thickness of carrier film which may also be used to adjust and control the curing times and surface hardness of the coating. It is well known to coat newly manufactured steel(s) and corrosion sensitive metal(s), with organic, or metallic, or high-performance plastisol coatings and finishes. For example; Corus UK Limited are known to protectively coat steel products, examples of these are Colorcoat Celestia, Colorcoat Pvf2 and Colorcoat HPS200. Furthermore, impression rollers are used to texture some products but the process is expensive and limited in its application.

The optically clear UV curable transfer coating of the present invention may be applied to steel products as a protective sealer layer, alternatively a wide variety of colours, pigments and metallic particles may be added to produce a durable UV coating which, may be further enhanced with UV blockers, photo-realistic images, text, light reflective and refractive particles, anti-scratch hardeners, non-slip particles, and other suitable components. The method of the present invention conveys numerous advantages in comparison with conventional metal painting, roller coating, spraying, dipping or curtain coating, for example. When the transfer coating is cured onto steel through the transparent polyester carrier layer an oxygen free curing environment is created and the usual odours and ozone emissions associated with conventional UV curing are prevented, the curing time is faster, and coating hardness is improved.

### Backing Layers

The durable image of the present invention may be provided with an additional backing layer either for protection or for a particular end-use, as described herein below. For example a metal (including any magnetic material), glass, plastic, cardboard or woodblock backing layer may be provided, for instance, to enhance the strength of the image-carrying substrate. Adhesion to the backing layer may be effected using a double sided film such as Steratape, or Hunt Europe/Seal USA Printmount PM1 or PM9. Many other types of adhesive, such as acrylic or rubber-based adhesive, as known in the art can also be used. The adhesive may be applied as a coating from a solvent-based system, or by any other convenient means. In some cases it is possible to obtain a backing layer with the adhesive already adhered thereto and ready for use once a protective overlay is removed.

The composition of the image which is to be applied to the substrate may be derived from a conventional photograph. In this case, the image of the photograph may be reproduced on the substrate using a conventional electrostatic copying device as described herein. Alternatively the image from a conventional photograph, negative or colour transparency may be digitally scanned and stored; the reproduction of the image may then be achieved using a computer and a laser printer. A particularly important aspect of the present invention is the reproduction of images taken by digital cameras and the printing thereof as photo-realistic images. In fact any image output from a computer, including images scanned into or generated by a computer, and whether or not enhanced or otherwise modified by the computer, can be applied to a substrate in the process of the present invention. Dimensional prints can be made from CAD design drawings generated using a computer and the appropriate software. Images could also include ultrasound images or colour X-ray images.

The method of the invention can be used to produce a wide variety of image-containing products in any size. Examples include self-adhesive labels, books, book bindings and book covers, manuals, workshop manuals, manuscripts, coated gloss and/or textured photograph albums and digital image albums, gloss and textured photo display for advertising, textured photos and photo-enlargements, coated textured ink-jet posters, textured metallic photo wall plaques, floor and wall coverings including textured floor tiles, all weather maps and point-of-sale photo displays, textured plastic and metal signage including estate agent's boards, metal mounted signs, magnet signs for external and internal application, illuminated signs, anti-glare car registration plates, anti-glare reflective road signs, external markings, currency including bar codes, smart cards comprising DNA signatures, smart credit cards, identity cards, photo-certificates, securing devices and passes optionally comprising in their embodiment electronic programmable chips and recognition chips, driving licenses and other documents which may contain a photograph, documents comprising micro-text, documents comprising reflective and refractive security particles and holograms and printed circuits.

In one embodiment, durable images of the present invention are in the form of self-adhesive stickers produced by applying onto one side of the substrate a double-sided adhesive film having a protective release layer on the side of the double-sided adhesive film remote from the substrate of the durable image.

In another embodiment, the durable images are in the form of a photograph album. A photo-realistic image produced from a digital photograph using the method of the present invention may consist of one or many individual images on a single sheet, which may carry images on one or both sides thereof. A number of such sheets can be bound together to form a photograph album in which the images are an integral part of each page, unlike conventional albums in which paper photographs are individually mounted on a stiff card substrate or page.

In the case of medium and large format illuminated signs the substrate may be a white, transparent or translucent Melinex (trade mark) film material, such that an ink-jet image is illuminated when a light is positioned behind the substrate. Reflective signs can be produced by depositing the image on a transparent substrate and providing a backing layer of reflective material. Suitable reflective material for use as the reflective backing layer include Macmark and Maclite 1010 (produced by Mactac), 3M Reflective (produced by 3M) and Cibalite (produced by Ciba-Geigy).

In another embodiment, UK and European vehicle registration plates can be produced quickly and inexpensively by thermally printing the required registration and customer personalization. According to 2000/2001 UK/European legislation post codes referencing the plate assembler's address must be displayed. In the present invention the registration and text are printed onto a Scotchlite (trade mark) reflective in the sizes and formats laid out by British and European legislation (incorporated into this document by reference) preferably using a thermal printer (suitable printers are marketed under the brand names Kroy and Merlin) and a Jepson & Company number-plate software package. The reflective is then laminated onto a rigid substrate, for example a BSI approved plastic (PET) or aluminium sheet. The reflective and the substrate are cold bonded together using an all weather double sided mounting adhesive. Subsequently the reflective is coated with a UV curable transfer coating which is rolled onto the printed reflective by jointly passing the UV curable transfer coating and reflective coating through a pair of heated rollers. The curable transfer coating may include a scratch resistant gloss or matt anti-glare surface which can be interpreted by roadside speed cameras. Holograms, bar codes, identification chips, light sensitive particles and other devices can be introduced into the transfer coating before curing takes place. Instant curing of the transfer coating is achieved when the coated reflective layers are passed in front of a UV light source.

Products produced according to the invention may further contain a hologram, bar code, microchip, or other means of authentication or identification, which may be encapsulated between the substrate and the UV curable transfer coating or within either the substrate or UV transfer coating. Authentication or identification means could also be provided by other electronic circuitry or devices such as printed plastic circuit or organic light emitting polymer circuits or displays or DNA signatures

In another embodiment heavy depositions of dot toner may be increased in height by the application of a UV curable transfer coating therefore producing an easy low cost Braille printing method for the blind.

The method of the present invention conveys numerous advantages in relation to existing lamination techniques using conventional transparent film and adhesive to protect and cover an image-carrying substrate. For instance, the curable transfer coating may be applied to give a thickness which is much less than that of a conventional transparent film and adhesive and the optical clarity and brightness of the curable coating allows for the production of high-quality images. The use of a UV curable transfer coating also provides a durable, scratch-resistant weatherable long-lasting image.

An important advantage of the present invention is its ease of use, enabling the rapid production of durable, photo-realistic images using conventional printing equipment. Using the method of the present invention, a wide variety of image-carrying products can be quickly and economically manufactured in large or small numbers.

According to a second aspect of the present invention there is provided apparatus for forming a durable image on a substrate comprising means for depositing an image on a substrate, means for applying a curable coating over the image and means to cure the coating.

The apparatus may include means for feeding the substrate either as individual sheets or as a roll of substrate material. Where a roll of substrate material is used the apparatus may include a suitable cutting means to convert the roll into individual sheets, either before or after imaging. Such an arrangement allows the size of the resultant image sheet to be selected by the user.

The apparatus preferably includes means, preferably a computer, for controlling the image-deposition means. The apparatus may be adapted for connection to a digital camera, video camera, scanner or other source of digital images.

The means for depositing an image may include an electrostatic image deposition means, and ink-jet image deposition means or any other suitable means.

Where an electrostatic image-deposition system is used, which may involve application of a toner stabilizer as described herein, the apparatus preferably further includes a means for removing toner stabilizer from the image-carrying substrate following deposition of the image. Such means may include the application of a detergent or other cleaning solution, as hereinbefore described. The apparatus may include a motorized roller brush. The apparatus optionally further includes a means for drying the image-carrying substrate following the removal of toner stabilizer, for example a hot air blower.

The apparatus may include means for removing contaminating dust particles from the surface of the substrate prior to coating. Such means may include a pair of particle-transfer rollers having a surface of low-tack adhesive rubber through which the image-carrying substrate is passed. The contaminated rubber of the rollers is then contacted with a means, for instance a pressure-sensitive adhesive film, for removing the contaminating particles therefrom.

The substrate may include a thermoplastic polymeric material. The curable coating may be a transfer coating and may be UV curable.

The means for applying a UV curable transfer coating preferably includes an apparatus comprising a pair of adjustable nip rollers of which at least one roller is heated.

The means to cure the coating is preferably a UV source, and may be powered by a microwave energy source.

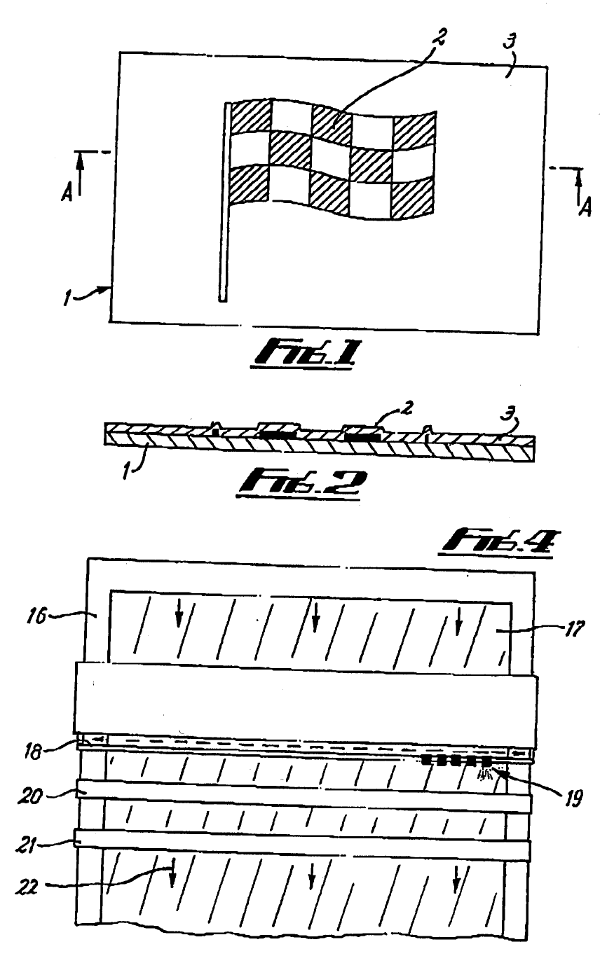

The foregoing and other objects, features and advantages of the disclosure will be apparent from the following more particular description of preferred embodiments of the disclosure, as illustrated in the accompanying drawings in which like reference characters refer to the same parts throughout the different views. The drawings are not necessarily to scale, emphasis instead being placed upon illustrating the principles of the disclosure. The principles and features of this disclosure may be employed in varied and numerous embodiments without departing from the scope of the disclosure. Referring to FIGS. 1 and 2 a sheet of coated polyester film 1 carries an image, formed by a toner 2 deposited on its surface. The toner 2 forms a relief pattern as it does not substantially penetrate the polyester film 1. The thickness of toner 2 varies, according to the density at which it has been applied. A layer of cured, optically-clear transfer coating 3 covers both the film 1 and toner 2.

The present disclosure will be further illustrated by the following examples, which are intended to be illustrative in nature and are not to be considered as limiting the scope of the disclosure.

### WORKING EXAMPLES

### Example 1

An opaque sheet of coated biaxially oriented polyethylene terephthalate Melinex 506 film is placed on a Canon colour photocopier and an image electrostatically deposited thereon. The film is then washed in a warm aqueous solution of detergent, and dried with a soft lint-free cloth. A hot-melt UV-curable, optically-clear transfer coating comprising an acrylate resin is applied to a transparent 100 micron Melinex polyester carrier film using a conventional Meyer/K1-bar, as known in the art, to effect drawdown of the lacquer across the surface of the film. The transparent carrier and the UV curable transfer coating are together laminated onto the printed surface of the image-carrying layer using heat and pressure from a pair of heated rollers, thereby covering the image. UV light powered by microwave energy is then directed onto the UV curable transfer coating causing it to cure through the carrier film. The cured layer has a dry thickness of about 20 microns. The carrier film may then be peeled away from the cured coating to reveal a replicated gloss and/or a textured finish (which replicates the texture of the carrier film) on the cured coating.

### Example 2

A process using a printable reflective layer imaged with black digits in the form of a vehicle registration plate. A printed reflective (Maclite 1010) is laminated onto a rigid perfect fit backing substrate using double-sided mounting adhesive. A hot-melt UV curable coating supported on a transparent polyester transfer film is positioned across the image-carrying layer thereby covering the image. The image carrying reflective layer and the coated carrier layer are bonded together using heat and pressure from a pair of heated rollers. UV light is then directed onto the coating, causing it to cure.

### Example 3

A process using an ink-jet image printed onto a Melinex translucent backing material and protectively coated with an anti-scratch UV curable transfer coating. A transparent carrier layer carrying the UV curable transfer coating are together bonded onto the image-carrying layer using heat and pressure. UV light is directed onto the lacquer which cures through the transparent film. When the coating is cured the carrier layer is peeled away from the hardened coating to reveal a high gloss or a matt surface finish dependent on the type of carrier which was used. The resultant ink-jet coated image can be illuminated from behind to produce a backlit illuminated sign or display. It should be noted however that water based ink images are normally laminated with an optically clear film and adhesive because an ink image may dissolve on contact with liquid. It may be necessary to remove mechanical corruption such as moisture trapped between the coating and the ink-jet image of the present invention. For this purpose a high voltage discharge may be used to ensure a strong bond is achieved between the image-carrying layer and the cured UV coating.

### Example 4

A 50 micron DuPont Teijin transparent polyester film coated with a DuPont Teijin in-line release layer (reference DTF8) was further coated with an Akzo Nobel aqueous based solvent free 100 percent solids UV curable polyurethane transfer coating having a finished thickness of 4.9 microns. The film and polyurethane layer was exposed to infrared light to evaporate the moisture from the polyurethane coating until the coating became dry to the touch and repositionable over an image.

The transfer coating and supporting film were then hot laminated onto a photo-realistic ink-jet or toner printed image on a paper substrate using heat and pressure from a heated roller laminator at a temperature of about 85° C. and a pressure of about 125 psi. As a result the transparent carrier film and transfer coating were bonded to the imaged substrate.

The laminated carrier and print layers were subsequently exposed to UV light to cure the polyurethane transfer coating.

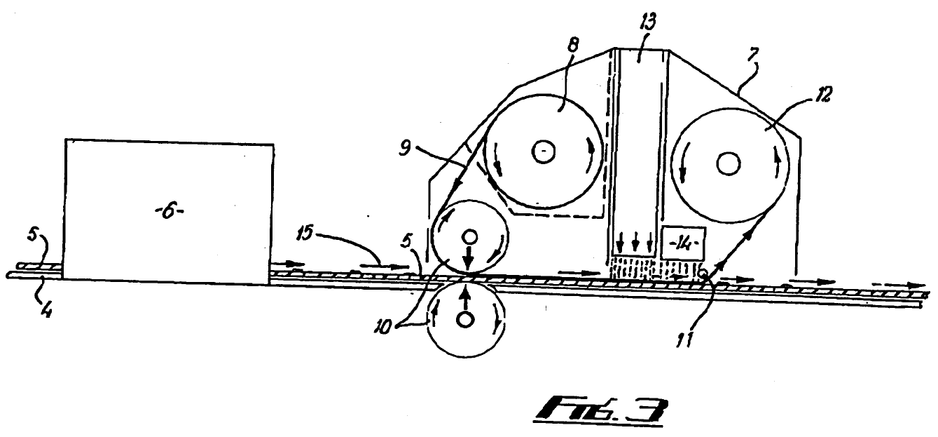

FIG. 3 shows apparatus for forming a durable image.

The apparatus includes a surface 4 for supporting a substrate 5, means 6 for depositing an image on a substrate and means 7 for depositing a curable coating on a substrate.

The means for depositing an image 6 may include a conventional photocopier or printer, such as an ink-jet printer.

The means for depositing a curable coating includes a removable light tight cartridge 8 housing a roller supporting a roll of carrier film 9 coated with a hot melt UV curable coating. The cartridge 8 is arranged to allow the carrier film to pass between two heated pinch rollers 10 to a guide roller 11 and then on to a take up roller 12. In the path between the pinch rollers 10 and guide roller there is disposed a UV source 13, for example a medium pressure Mercury lamp, and a source 14 of cooling air, such as a motor driven fan.

In use a substrate 5 to be coated travels through the apparatus over surface 4 in the direction of arrows 15. The substrate 5 first passes through the means for depositing an image 6 which deposits an image on the substrate 5. The imaged substrate 5 then passes between the heated pinch rollers 10 which urge the substrate in contact with the coated carrier film 9 whilst heating the carrier film 9 and substrate 5 sufficiently to melt the coating so that the coating adheres to the substrate 5.

The substrate 5 and carrier film 9 combination then passes beneath the UV light source which causes the coating to cure, and then beneath the cooling air source 14. The carrier film 9 is then taken up by the take up roller 12 and the substrate 5 passes out of the apparatus causing the carrier film 9 to peel off the substrate 5 leaving the coating on the substrate 5, over the image.

FIG. 4 shows a different embodiment of apparatus for forming a durable image. The apparatus includes a surface 16 for supporting a substrate 17. A track 18 supporting a number of ink-jet print heads 19 extends laterally across the surface 16, followed by an infrared or hot air source 20 and a UV source 21 which also extends laterally across the surface 16.

One or more of the ink-jet print heads 19 are arranged to deposit an aqueous ink onto a substrate 17 on the surface 16 and one or more of the heads is arranged to deposit an aqueous curable coating onto a substrate 17 on the surface, over an image on the substrate.

The infrared or hot air source 20 is arranged to direct infrared radiation or hot air towards a substrate on the surface 16 and the UV source is arranged to direct ultra violet radiation towards the substrate 17.

In use a substrate is periodically advanced along the surface 16 in the direction of arrows 22. When the substrate is static the ink-jet heads travel along the track 18, across the substrate and deposits ink on the substrate, where required, to form an image, and a curable coating over the entire width of the substrate and any image thereon. As the substrate advances it first passes under the infrared hot air source 20 where the ink and/or coating is dried and then under the UV source which causes the coating to cure.

The above embodiments are described by way of example only. Many variations are possible without departing from the invention.

What is claimed is:

1. A method of encapsulating an article within a coating of a substrate comprising the steps of:
providing a substrate;
applying a first receiving layer of a curable coating on the substrate;
introducing an article to be encapsulated;
applying a second layer of a curable coating to the substrate over the receiving layer; and
curing the coating, wherein the article is encapsulated within the coating.

2. The method of claim 1, wherein one or more additional layers of curable coating are applied over the second layer of curable coating.

3. The method of claim 1, wherein a plurality of articles is introduced.

4. The method of claim 2, wherein an article is introduced into one or more of the additional layers of curable coating.

5. The method of claim 1, wherein the coating is cured using ultra violet radiation.

6. The method of claim 1, wherein the layers of curable coating are applied by transferring them from a carrier.

7. The method of claim 6, wherein the article is introduced to the second coating layer before the second coating layer is transferred from the carrier to the substrate.

8. The method of claim 6, wherein the coating is heated to facilitate bonding to the substrate.

9. The method of claim 6, wherein the layers of coating are cured before the final layer of coating to be applied is transferred from its carrier.

10. The method of claim 1, wherein the article is an authentication means.

11. The method of claim 1, wherein the substrate is a vehicle registration plate.

12. The method of claim 1, wherein the substrate includes a smart card.

13. The method of claim 1, wherein the substrate includes a bank note.

14. The method of claim 1, wherein the substrate includes a document.

15. A method of forming a vehicle registration plate incorporating an encapsulated authentication means, comprising the steps of:
providing the text of the registration plate on a substrate;
applying a first receiving layer of a curable coating on to the substrate;
introducing an authentication means to be encapsulated;
applying a second layer of a curable coating to the substrate over the receiving layer; and
curing the coating, the authentication means thereby being encapsulated within the coating.

16. The method of claim 15, wherein the text of the registration plate is printed onto a material which is then laminated to the substrate.

17. A method of forming a durable image comprising the steps of:
providing a substrate;
depositing an image on the substrate;
applying a curable coating over the image; and
curing the coating.

18. The method of claim 17, wherein the substrate is not absorbent to the image forming material.

19. The method of claim 17, wherein the substrate is absorbent to the image forming material.

20. The method of claim 17, wherein the substrate includes a plastics material.

21. The method of claim 20, wherein the substrate is formed from polyethylene terephthalate.

22. The method of claim 17, wherein at least part of the substrate is coated with a primer and/or receiving layer.

23. The method of claim 17, wherein the image is deposited on the substrate using an electrostatic process.

24. The method of claim 23, comprising the step of cleaning the substrate after deposition of the image but before applying the coating.

25. The method of claim 17, wherein the image is deposited on the substrate using an ink-jet printer.

26. The method of claim 17, wherein the coating is applied by transferring it from a carrier.

27. The method of claim 26, wherein the coating is heated to facilitate bonding to the image bearing substrate.

28. The method of claim 26, wherein the carrier is textured in order to give the coating a texture.

29. The method of claim 28, wherein the carrier is textured in such a manner that the coating has a lenticular surface.

30. The method of claim 17, wherein the coating is sprayed over the image.

31. The method of claim 17, wherein the coating is water based.

32. The method of claim 31, including the step of drying the coating after application, but before curing.

33. The method of claim 17, wherein the coating is cured using ultra violet radiation.

34. The method of claim 17, wherein the durable image includes a photo-realistic image.

35. An image carrying article comprising an image formed by the steps of:
providing a substrate;
depositing an image on the substrate;
applying a curable coating over the image; and
curing the coating.

36. An apparatus for forming a durable image on a substrate comprising:
means for depositing an image on a substrate;
means for applying a curable coating over the image; and
means to cure the coating.

37. The apparatus of claim 36, wherein the means for depositing an image includes an electrostatic image deposition means.

38. The apparatus of claim 37 comprising means for cleaning the substrate after image deposition.

39. The apparatus of claim 36, wherein the means for depositing an image includes an ink-jet image deposition means.

40. The apparatus of claim 36, wherein the means for applying a curable coating includes means for applying a transfer coating.

41. The apparatus of claim 40, wherein the means for applying a transfer coating includes a pair of nip rollers at least one of which is heated.

42. The apparatus of claim 36, wherein the means for applying a coating includes an ink-jet type means.

43. The apparatus of claim 36, wherein the means to cure the coating includes a source of ultra violet radiation.
